(19) United States
(12) Patent Application Publication
(10) Pub. No.: US 2007/0199077 A1
(43) Pub. Date: Aug. 23, 2007

(54) SECURE COMMUNICATION SYSTEM

(76) Inventor: Andrew J. Czuchry, Auburn, GA (US)

Correspondence Address: W. EDWARD RAMAGE, COMMERCE CENTER SUITE 1000, 211 COMMERCE ST, NASHVILLE, TN, 37201, US

(21) Appl. No.: 11/677,900

(22) Filed: Feb. 22, 2007

Related U.S. Application Data
(60) Provisional application No. 60/775,705, filed on Feb. 22, 2006.
(60) Provisional application No. 60/775,581, filed on Feb. 22, 2006.

(51) Int. Cl. H04L 9/32

(52) U.S. Cl. 726/27

(57) ABSTRACT

A secure communication system comprising a data transmission system for transmitting content, and a security system integrated with the data transmission system. The security system defaults to lock-out mode, so that any user of the data transmission system must first request access and no access is granted without the request being authenticated. The content may be encrypted or encapsulated, or both. Tracking and reporting functionality is provided. Content can include messages, videos, music, email, and other forms of data. In one embodiment, content transmitted to a content-receiver can be stored by the content-receiver and accessed at a later time.

This application claims priority to U.S. Provisional Patent Application No. 60/775,705, filed Feb. 22, 2006, by Andrew Czuchry, and U.S. Provisional Application No. 60/775,581, filed Feb. 22, 2006, by Andrew Czuchry, and is entitled in whole or in part to those filing dates for priority. The disclosure, specification and drawings of Provisional Patent Application Nos. 60/775,705 and 60/775,581, and U.S. patent applications Ser. No. 10/986,972 (“Apparatus and Method Providing Distributed Access Point Authentication and Access Control with Validation Feedback,” Czuchry, et al., filed Nov. 12, 2004), Ser. No. 10/914,693 (“Content Distribution and Incremental Feedback Control Apparatus and Method,” Czuchry, et al., filed Aug. 9, 2004), Ser. No. 11/269,444 (“Content Distribution and Incremental Feedback Control Apparatus and Method,” Czuchry, et al., filed Nov. 8, 2005) are incorporated herein in their entireties by reference.

### TECHNICAL FIELD

The present invention relates to information management and telecommunications systems. More particularly, the present invention relates to a secure communication system that has integral security features and is extensible, where content can be tracked.

### BACKGROUND OF THE INVENTION

As the speed of business increases, companies move rapidly toward increasing productivity instead of adding personnel and overhead. As industry becomes ever more global, the need to incorporate flexible, scalable, secure communication options into the fabric of daily practice becomes all the more critical. An executive on one side of the globe sending a crucial visual report to his counterpart eight time zones away must have an empowering, secure, communication technology that harnesses the strength of the Internet and leverages the power of creative content.

As television, telephone and computer technologies converge, entertainment and information gathering companies seek alliances with resource companies that can securely transport and download content. Yet the current streaming video options that present tiny images with questionable visual quality are not the public pleasing options content companies are seeking. The digital rights management (DRM) solutions that are required to protect the content companies' copyrighted material from being stolen are easily decoded, affording little real copyright protection. The computer download option for content sales remains a nascent industry. It needs a secure, communication technology that harnesses the strength of the Internet and leverages the power of video and audio file transmission that provides full screen DVD quality playback regardless of bandwidth.

When a global pharmaceutical company's account rep receives his weekly selection of training information and regulatory data in a box of CDs or DVDs, his company has no way of knowing he reviewed the content. If he is traveling and does not receive and review the data in a timely manner, he may be missing critical updates that are important references for his client's use. He and his company need a secure, communication technology that harnesses the strength of the Internet and leverages the power of content delivery and review notification.

A research company must deliver time sensitive, content rich information to its Fortune 500 clients. Daily updates with a volume of messages as high as one million or more each day must arrive at the proper recipient with arrival and delivery notification—with no lost content and no incorrect deliveries. The company needs a secure, communication technology that harnesses the strength of the Internet and leverages the power of high volume content distribution regardless of file size and the number of files and destinations required.

Communicating effectively is more than just getting content from one location to another. Truly communicating effectively also means understanding human behavior—understanding how people receive, review and use information. Although the requisite underlying technology can be complex, communication technology is only good when it is simple for the user to use. It must be feature rich behind the scenes and easily accessible and intuitive on the surface. The fundamental challenge of making a complex solution simple for the user at the human behavior level derives from the complexity of the solution itself: the deeper you dig into solving the human behavior issues, the more complex the technology becomes in order to provide that solution.

A blending of key elements is needed in order to synthesize all the requirements into a single solution. Content has to be sent directly to the person that needs to receive it, and not wait for the person to request it. It has to be available and tracked whenever they need it, whether they are currently connected to a network or not. It has to be independent of the bandwidth available. It has to be securely transmitted and securely accessed. Recipients must know when their content has arrived without having to search the web or sort through a cluttered e-mail list. The sender must know when the material was delivered and reviewed.

The principles of harnessing and leveraging lead to new ideas and business solutions. The principle of harnessing produces foundational technology. The principle of leveraging can enhance productivity. Together, harnessing and leveraging create the potential for rapidly expanding opportunities. For example, harnessing electricity, appearing naturally as lightning, set us along a route that has transformed the way we live and work. Harnessing electricity, as a foundational technology, led to the leveraging of electricity through the perfecting of the carbon filament fiber. Since running electricity through the filament can create light, a light bulb leverages electricity. Businessmen leveraged electricity to build factories. Factories leveraged electricity to run machinery needed to build the commodities they sold. As a result, the harnessing of electricity contributed to the explosion of the industrial revolution. The leveraging of electricity, in turn led to the discovery of other foundational technologies. The automobile leveraged a number of these technologies—from the battery to the internal combustion engine. In turn, the auto became a foundational technology which inspired the creation of the assembly line, still another foundational technology for efficient mass production. Toasters, TV sets and computers leverage electricity and the assembly line. Harnessing foundational technologies helps us improve the way we live and work through the leveraging of those technologies.

In the world of computer technology, Microsoft Corporation's Windows® has become the equivalent of the harnessing of electricity. Ninety-five percent of the world's PC's, servers and laptops leverage Windows® through productivity programs like Microsoft Word®. Productivity programs can leverage Windows® to manipulate the hardware; users interact with Windows® to manipulate and use the productivity programs. Windows® market power comes, mainly, from the foundation it lays.

Unlike Windows® which is a foundational technology, e-mail, the globally accepted method for communicating, is a productivity program. It leverages elements of the foundational technology we know as the Internet and does one thing reasonably well—it gets messages from one mailbox to another. Its market power comes mainly from the business solution it provides rather than the foundation it lays.

The rapid rise and maturation of the Internet as a preferred mode of information dissemination has irrevocably changed the way we learn, communicate and do business. On one hand it is a marvelous tool that has enhanced both business and personal communication. On the other, it is an open window to a house filled with information—both public and private—through which thievery is not only common, it's rampant. The only way information stored on a computer can ever be kept safe is to keep the computer disconnected from any outside communication technology and locked up in a room with 24/7 surveillance. That, however is as impractical as keeping your money buried in a jar in your back yard, only to dig it up whenever you need to spend some. We cannot work with all our data stored in a locked safe with no access and no practical way to share that data when required. Therefore, secure communication technology with the ability to safeguard and safely transport data from one person to another using the Internet—without fear of data theft—means security cannot be merely a feature of communication technology; it must be the foundation of the technology.

Communication technology is like a hollow pipeline through which data flows. That pipe however has limitations. Just like an oil pipeline, the goal is to make the pipe itself as strong as possible so that the content can't “leak out”. When the pipeline is buried in the ground it appears to be safe from harm. The perception is, therefore, the content in the pipe is safe. But suppose a trench above where the pipeline is buried needs to be dug; and suppose a powerful trench cutting saw cuts too deeply and slices a gash in the pipeline. Out leaks the content. Sometimes, thieves will tap into a pipeline and steal some of content. Precautions need to be taken to prevent terrorists blowing up a pipeline. That trench cutting saw is the technological equivalent of a security flaw or weakness. The thieves and terrorists are the equivalent of hackers and attackers who hide in the murky world of internet security skullduggery.

In addition, in a corporate environment, the cost and complexity of upgrading security systems often mitigates against staying current, much less anticipating the need for security changes. Security can be readily eclipsed if security is not included in the foundation of a communication technology. As a practical matter, security that is not woven into the very core of a system results in the system becoming a leaky sieve. Further complicating the issue, however, is the fact that the leaky sieve nature of a system's design does not become apparent until after a security breach occurs. While no system can effectively provide both ubiquitous connectivity and completely impenetrable security, the foundation upon which a system is built does determine the security issues that eventually percolate throughout the entire system.

This leads to a key question: How does business use technology and the internet to solve the human behavior issues that are inexorably woven into successfully communicating with people, while making the complex solution simple for the user at the human behavior level? More specifically, “How can we send messages to thousands of disparate desktops spread across the country, know they received the material and also know that they watched it?”

Accordingly, there is a need for a communication system that has integral security features and is extensible, where content can be tracked.

### SUMMARY OF THE INVENTION

This invention is directed to a system for the secure transmission of data and content. In one exemplary embodiment, the system comprises a data transmission system for transmitting content, and a security system integrated with the data transmission system. The security system defaults to lock-out mode, so that any user of the data transmission system must first request access and no access is granted without the request being authenticated. The content may be encrypted or encapsulated, or both. Tracking and reporting functionality is provided. Content can include messages, videos, music, email, and other forms of data. In one embodiment, content transmitted to a content-receiver can be stored by the content-receiver and accessed at a later time.

In another exemplary embodiment, components of the present invention include a messenger component and clients component that may be integrated or used in conjunction with an existing system, such as a local area network. One or more components may communicate with a core controller outside the LAN. This communication may be conducted through a firewall or similar security means. A content server may be located inside or outside the LAN.

### BRIEF DESCRIPTION OF THE DRAWINGS

FIG. 1 is a schematic illustration of an extensible secure control system backbone in accordance with one exemplary embodiment of the present invention.

FIG. 2 is a schematic illustration of encapsulated security packets transferred and stored within the control backbone illustrated in FIG. 1.

FIG. 3 is a schematic illustration of the functional abstraction layers embodied within the control backbone illustrated in FIG. 1.

FIG. 4 is a schematic illustration of a secure communication system in accordance with one exemplary embodiment of the present invention.

FIG. 5 is a schematic illustration of a secure communication system in accordance with another exemplary embodiment of the present invention.

FIG. 6 is a schematic illustration of a secure communication system in accordance with another exemplary embodiment of the present invention.

### DETAILED DESCRIPTION OF EXEMPLARY EMBODIMENTS

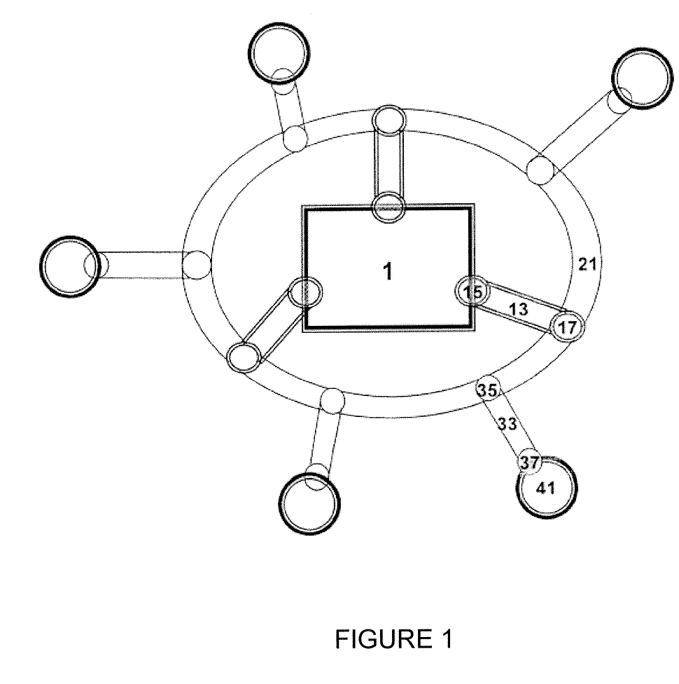

FIG. 1 shows a exemplary embodiment of a closed-loop secure system with integrated feedback encompassing a secure ring of connectivity and control flow distribution 21, with a secured core of program logic 1, and secured closed loop endpoints 41. Each of these elements, 1, 21, 41, can independently function as a stand-alone element, with defined rules of interaction programmatically integrating the elements as controlled through the program logic of the secured core 1.

Connectivity between the control flow distribution ring 21 and the secured core of program logic 1 is enabled through the connectivity control which produces a connectivity flow control tunnel 13. The security of connectivity control is managed by the programmable flow control valves 15, 17 that secure each end of the connectivity flow control tunnel 13 with secured authentication. Each control point intersection within the loop behaves like a flow control value that is opened only with the presentation of the proper credentials. Unique authentication identifiers ensure closed-loop security is maintained at the level of loop access/entry and within the loop itself.

Connectivity of the individual end points 41 to the control flow distribution ring 21 is managed through the secured extensibility tubes 33. The secured extensibility tubes 33 are secured by the programmable flow control values 35, 37 that secure each end of the extensibility tube 33 with secured authentication. Authentication can be performed at every interface interaction to ensure security is not breeched.

The computational processing result is that the program logic 1, the connectivity control 13, the ring of connectivity 21, the extensibility tubes 33, and the secured end points 41 form the secure control backbone. Internal flow control is programmatically provided by flow control valves with secured authentication 15, 17, 35, 37. These programmable flow control values are controlled through the program logic encoded in the control core 1. The program logic encoded within the control core 1 provides unique identity mapping control for all access into, within, and across the entire closed loop system.

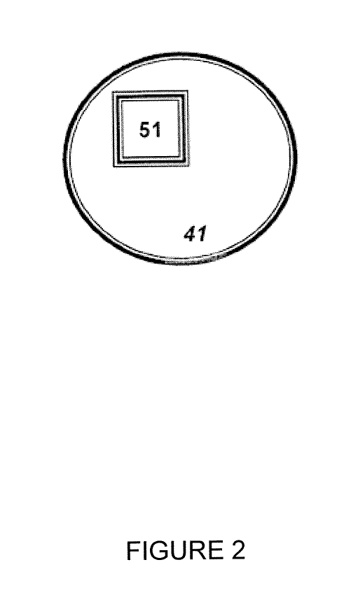

FIG. 2 is a schematic illustration of an encapsulated security packet of content 51, as stored in secured end-point 41, in accordance with an exemplary embodiment of the present invention. This secured packet of content 51 may embody an encryption header, authentication requirements, routing information, and content encryption. The encapsulated security packet of content 51 can be transmitted through the control backbone 1, 13, 21, 33, 41 with flow control provided through programmable flow control valves 15, 17, 35, 37. Digital content is packetized into the encapsulated packets 51, and the storage, transmission, and reconstitution of the digital content is controlled by interlacing encapsulated packets 51 based upon programmable control logic encoded in the control core 1. Presentation of improper credential destroys the interlacing process and thus ensures protection of the original digital content.

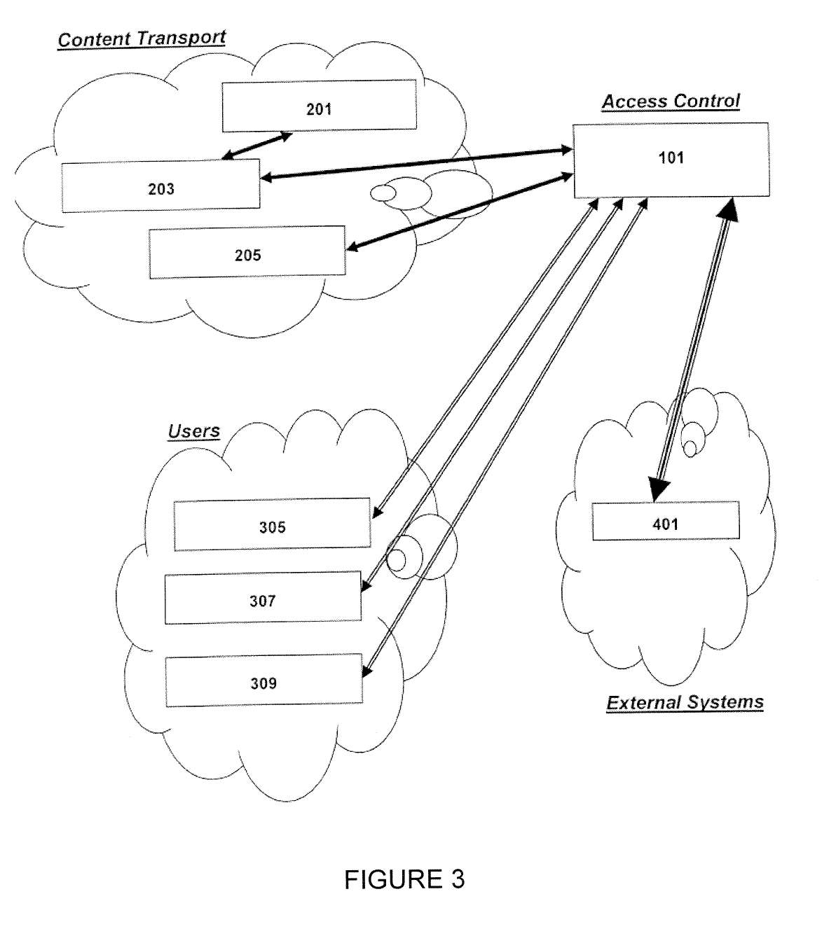

FIG. 3 is a schematic illustration of functional abstraction layers embodied within the control backbone of FIG. 1, in accordance with one exemplary embodiment of the present invention. A secure access control abstraction layer is maintained through the access security module 101. This module provides an abstraction layer for functionality including but not limited to authentication, encryption, digital rights management (DRM), digital signatures, access control, and logical connectivity.

The secure transport functionality abstraction layer is maintained through three control modules: transmission 201, communication backbone 203, and the content repository 205. The transmission module 201 provides an abstraction layer for functionality including but not limited to physical content format, bandwidth availability, and physical connectivity. The communication backbone module 203 provides an abstraction layer for functionality including but not limited to send, track, receive, review, and feedback capture. The content repository module 205 provides an abstraction layer for functionality including but not limited to the encapsulated content.

The productivity module abstraction layer is maintained through one or more productivity modules 309. The productivity module 309 provides an abstraction layer for functionality including but not limited to audio/video content, library archives, graphical content, and formatted text content. A secure integration to external systems abstraction layer is provided through the system integration module 401. The system integration module 401 provides an abstraction layer for functionality including but not limited to secured external links (e.g., links to subscription services).

The system can be realized as a hardware implementation, or a software implementation, or a mixed mode hardware and software implementation. While the actual digital content transferred through various application specific technologies may represent a variety of different messages (e.g., voice, music, video, graphics, pictures, or text messages), the synthesizeable core of each remains equivalent across the spectrum: packetized electronic data exchange 51. This core of packetized exchange is based on the transfer of the elemental digital packets 51 that comprise the digital content. The present invention was created to process this core exchange, and thereby facilitate virtually any type of content transfer, rather than merely serving as a specifically tailored solution for the actual category of content being processed.

Given the diversity of the digital universe where packaging and transferring digital packets of contents is becoming increasingly essential, building a foundational core technology has far-reaching application potential. This potential is greatly enhanced by basing the foundation on exchanging digital packets that are universal in nature and can encapsulate any specific type of content desired.

To achieve this objective, one embodiment of the present invention may be based on exchanging encapsulated digital packets of content 51, independent of the specific types of content. This embodiment has multi-dimensional universal application for any type of messaging (including, but not limited to, video, voice, data, and text). An embodiment also may be based on a programmatically extensible “closed system” 1, 13, 21, 33, and 41. This embodiment meets the needs of both foundational security and potentially universal connectivity. Based on an extensive understanding of human behavior, the system may flexibly integrate into business and personal environments and not impose restrictive models for user interaction. At its very core, embodiments of the present invention may facilitate the secure transport of digital information in virtually any human behavior context.

The net result of integrating each of the pieces into a unified system produces a virtual kaleidoscope of functionality while maintaining its multi-dimensional secure core 101. The extensible “closed system” foundation keeps the entire system secure at all times. The encapsulation of digital content packets ensures integrated extensibility and security for virtually any content format.

Given the ever-present and increasingly vital need for non-leaky security in an expanding universe of digital communication, embodiments of the present invention may be built with integrated security woven into its most basic core 1, 13, 21, 33, 41. Within this core, two fundamental dimensions of secure communication are inextricably intertwined: data transmission and transmission security 201, 203, and 205. By weaving these dimensions together in an intricate pattern at the very core, each is inseparable from the other. When leveraging the transmission capabilities of the technology 201, and even when adding new aspects of transmission functionality, security remains a fundamental part of the technology.

The security woven into the communication core 101 ensures that any system application using some embodiments of the present invention defaults to “lock out” mode. In this mode, any application utility or application users must specifically request secure access and no access is granted without authenticating the request. This woven security approach is in direct contrast to systems where security specifically specifies “access that is prohibited.” The contrast is most apparent when reviewing the default behavior. The default behavior of the present invention is that people cannot access any information unless specifically granted rights to access that information. The default behavior of the contrasting “specifically prohibited” approach produces a by-product of unintended results such that people can effectively access information unless explicitly prohibited from such access. Even if “specifically prohibited” is extended to the outermost levels of security, the typical result is still a sequence of “patching security holes” as issues are exposed through users accessing information inappropriately. By weaving security into the very core of all functionality in the present invention, based on “lock out” modes that are opened only when authenticated access privilege is verified, the risk of compromised security is significantly mitigated.

Thus, in one embodiment, content rights can remain with, and be controlled by, the sender through encapsulation mechanisms as described herein. Similarly, content rights can remain with, and be controlled by, the sender through a controlled distribution and/or feedback loop. Content and content modules can be retracted via encapsulation mechanisms and/or control loop mechanisms, or by encapsulation mechanisms with or without a controlled distribution and/or feedback loop.

One embodiment of communication technology in accordance with the present invention (“tCom”) combines the principles of harnessing and leveraging together simultaneously. The power of the Internet is used to enable secure communication and secure communication modules are leveraged to meet business needs. tCom provides a secure communication backbone with tracking and feedback independent of bandwidth. tCom can perform a variety of functions independent of modules and productivity software that leverage the technology. For example, tCom can send, track, receive, review and provide feedback on data transmitted over copper wire, fiber, microwave signal, satellite transmission, power lines, or other transmission means. It can provide security through authentication, encryption, digital rights management (DRM), digital signatures, and other security techniques. It can be linked to and used with demographic data, subscription services, backend financial systems, and many other forms of data. It also can provide initial productivity modules for audio/visual send, receive and review messaging and reporting.

In one embodiment, tCom communication technology integrates security into the core transmissions technology. Data transmissions and transmission security thus are inseparable; security remains a fundamental part of the technology, even when adding or modifying aspects of transmission functionality. tCom integrates three distinct functional dynamics:

1. The universality of an “open system”,

2. The security of a “closed system”, and

3. The reality of human behavior factors.

### The integration of these three elements builds a framework for diverse application by being able to handle digital communication in an encapsulated and fundamentally secure manner. tCom merges the content encapsulation and the security mechanisms.

The security woven into the communication core ensures that any system application using tCom communication technology defaults to “lock out” mode. That means any application utility or application users must specifically request secure access, and no access is granted without authenticating the request. This woven security approach is in direct contrast to systems where the security control specifies “access that is prohibited.” The contrast is most apparent when reviewing the default behavior. The default behavior of tCom communication technology is that people cannot access any information unless specifically granted rights to access that information. The default behavior of the contrasting “specifically prohibited” approach produces a by-product of unintended results such that people can effectively access information unless explicitly prohibited from such access. Even if “specifically prohibited” is extended to the outermost levels of security, the typical result is still a sequence of “patching security holes” as issues are exposed through users accessing information inappropriately.

The key distinction between the alternatives of “specifically prohibited” and “lock out” mode is what happens if functional extensions to the system are not completely integrated with the existing security model. Given the “specifically prohibited” model, a security patch may be required to “close the hole” at any point where security is compromised. Given the “lock out” mode, a security patch may still be required, but for a different purpose; a patch may be required to “open the authorized channel” to grant authorized communication, but the security of the content has not compromised. Security is enhanced by the default behavior that patching required “to open channels” for authorized communication is preferable over patching required to “close holes” of compromised security. Therefore, by weaving security into the very core of all functionality in the tCom™ communication technology based on “lock out” modes that are opened only when authenticated access privilege is verified, the risk of compromised security is significantly mitigated.

With the confidence afforded by a core of integrated security, tCom communication technology can effectively become a backbone for virtually any secure digital communication system. Furthermore, since the tCom communication technology can function as an extensible backbone and not just an application, tCom communication technology can enhance existing infrastructure solutions that are already in development or are already deployed. The tCom communication technology can thereby functionally extend current technology applications and infrastructure. The tCom communication technology can also form the foundation of new innovations and solutions for secure communication of sensitive, private, and/or copyrighted data. Moreover, the tCom application modules are ready for deployment in a variety of video, data, and communication scenarios where existing business dynamics and processes may have gaps or holes that need to be filled with secure communication solutions.

tCom also can provide tracking and reporting functions. In one embodiment, the system provides a video messaging system with metrics that track productivity based on receipt and review notifications. This can help users measure the effectiveness of their internal communication strategies. The system can provide a securely transmitted, subscription strategy for delivering custom tailored data and video reports to subscribers. This can help users expand their market reach and effectiveness in the information dissemination industry. The system can provide file delivery for any size video file, with quality equal to the source material regardless of bandwidth available. This can help the distribution and quality of DVD and HDTV downloads for subscription or on demand for the broadcasting and motion picture industries while protecting their copyrighted material. Files can be sent on demand or by subscription with security at each stage of delivery and storage. This transmission capability can be also be applied to the mass transmission (secure and trackable) of files, without regard to volume or frequency. Similarly, the system can deliver response required training and educational material to schools, businesses, homes or elsewhere with equal quality, equal security, and equal reporting capabilities.

tCom communication technology forms a bridge over any communication gap, whether it be business-to-business, business-to-consumer, or consumer-to-consumer. Transmissions from room to room, or continent to continent, can be sent regardless of file size, format or content, and independent of bandwidth restrictions.

Over time, there will be new productivity programs and new technology modules for communications. tCom technology modules can be incorporated into these new software programs.

One particular area where tCom can be used is e-mail. E-mail has, for more than twenty years, been a popular and widely utilized productivity program. Its shortcomings, most notably its lack of security, have been outweighed by its universality. Because of e-mail, anyone can communicate with anyone else, globally. It is inexpensive to obtain, balky but not unfriendly, and could do one thing pretty well. E-mail does one thing pretty well too—gets messages from one mailbox to another—most of the time.

Over the years, the email system has changed little. It remains an often-used communication tool for business and a widely used convenience for the average user. In recent years newer tools like IM (instant messaging) and text messaging have entered the market and have become easy to use popular forms of internet communication. But like e-mail, their inherent lack of security and messaging limitations keep them from being a versatile, dependable, secure messaging tool. Until now, no new communication technology has been developed that can offer more in the way of service than e-mail.

With tCom communication technology, unlike standard e-mail, Internet messages can be sent securely. Unlike e-mail, the message is the message, meaning there are no attachments to be lost, rendered inoperable, or stolen. The size of the message, the volume of messages, the volume of recipients have no effect on the technology's ability to transmit and download. Unlike e-mail, which has virtually no reporting and tracking system, tCom communication technology's send, receive and review notification technology can be customized for a wide variety of business tracking and results reports. Its password protected send and receive technology guarantees the message will arrive at the receive end. This will prevent the case of the e-mail being lost or bounced back a day or two after the sender thought it had been safely delivered. It also provides a priority messaging strategy that breaks through the vast clutter of e-mail messaging.

In another exemplary embodiment, the practical implementation of user-centric design principles guide the features that are incorporated into the tCom communication technology. The fundamental driving factor is that features must be pulled through the system by users' needs and behavior rather than pushed on users as design ideas or system “enhancements”. While some user needs are predictable, many require flexibility so that the system can be integrated into their daily (business) life. When a user's needs are predictable, the system can be implemented in such a way that the user is given what they want. Then, they can use it flexibly when they want or need it, rather than forcing a user to repeat an extended process of “search and find and select and retrieve”.

tCom communication technology thus can provide users not only the predictability of handling what they want, but also the flexibility of being able to use what they want when they actually need it. In communication scenarios, this applies both to sending information and receiving it. Taking into consideration the independent needs, constraints, and time frames of senders and receivers of communicated information, tComcommunication technology meets the needs on both sides of the issue. For example, since the needs and schedule of the sender and receiver may not always coincide with the exact time in which information is needed, sending and receiving can be decoupled from the actual use process; messages can be sent on the sender's schedule, received on the user's schedule, and used on the user's schedule. All this while maintaining ultimate security throughout and efficiently providing feedback responses as applicable. The net result is that the appropriate information comes to each user as it is available for use when desired, rather than requiring the user to manually search, filter, and find the information dynamically.

Decoupling the processes of sending and receiving content facilitates content consumption because users can view the content on-demand; however, just decoupling is not enough because bandwidth requirements are pushed back to the broadcaster if some form of additional technology is not inserted into the equation. More technological enhancements must be inserted into the equation in order to handle the growing appetite for full broadcast quality, on-demand, time-shifted viewing by the user. tCom communication technology is ideally designed to be inserted into the basic on-demand content equation. Furthermore, since tComcommunication technology can provide the ability for users to view the content even when they are temporarily or intermittently disconnected from the network, great flexibility is added for mobile content availability. This also creates the ability to archive libraries of “time shifted” content.

Modularized approaches innovated, refined, and applied to solving complex interacting information system designs have laid the foundation for the core technology embedded within one embodiment of the tCom communication technology. Solid design principles incorporating modularized program elements (functional modularity) along with standardized plug-compatible object representations (foundational program elements and interfaces) provide an efficiently distributed computational architecture for broad flexibility in supporting innovative feature implementation. Given its modularized, plug-compatible design and implementation, the tCom communication technology can serve as a system architecture that not only sustains but also fosters rapid growth by providing both innovative and practical business solutions where the need for transporting information securely to people is of paramount importance.

In another exemplary embodiment, the present invention can be used to deal with security concerns with “confidential” or “copyrighted” or “private” or “limited access” information. Ensuring that any and all access to sensitive information is authorized, documented, tracked, and reported is vital for maintaining the security of that information. All too often, however, the privacy of information is compromised, either unintentionally or intentionally, through the storage and transmission mechanisms used to process the proprietary information. A number of significant security and privacy features are woven into the tCom communication technology, so that all content transferred through the system is protected appropriately. One important feature is the use of “authentication” mechanisms to ensure only authorized access is provided for any information and that the scope of access is appropriately localized (including audit trails and logging of access). Another important feature is that any demographic data that may be stored for communication is explicitly decoupled from each individual user, so privacy can be maintained in all communications. Extending known encryption technology (through trade secret integration of encryption and authentication processing) provides a safety net of security so that even if components of any communication were compromised, the content itself is still inherently protected. Packaging of information through encapsulation procedures provides further protection and privacy. Encapsulation methods are applied to content, routing, receipt, storage, and tracking in order to localize both interaction and exposure throughout the entire communication and storage processes.

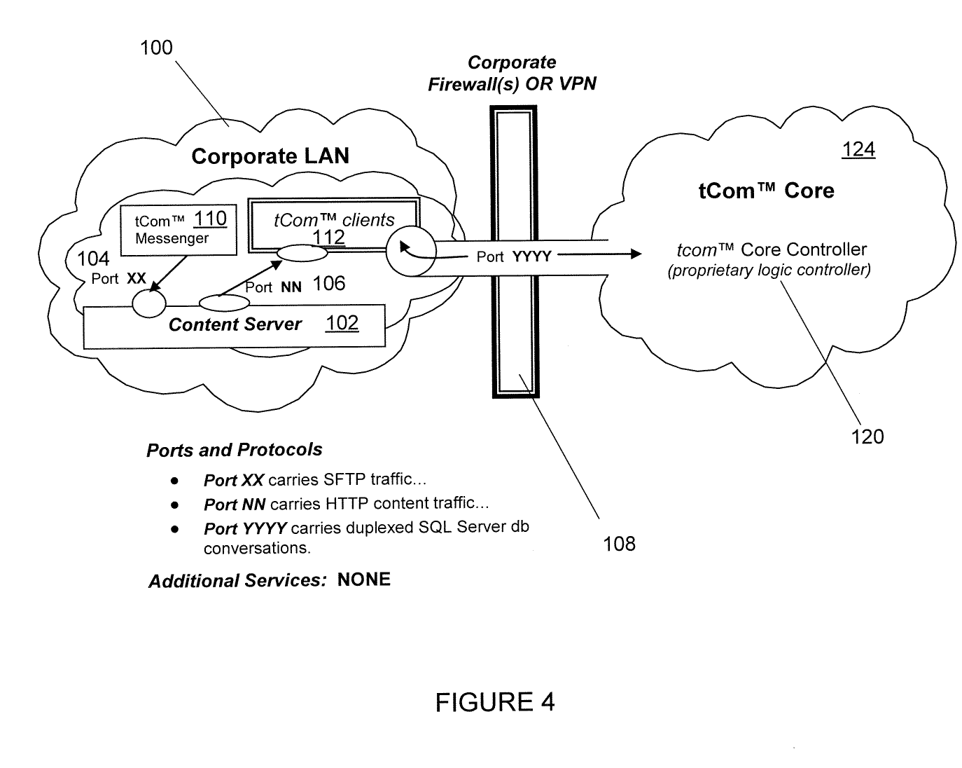

FIG. 4 shows a view of a secure communication system in accordance with one embodiment of the present invention. A corporate local area network (LAN) 100 has a content server 102 that communicates through communications ports 104, 106. The corporate LAN 100 further includes a tCom messenger component 110 and tCom clients component 112 in communication with the content server 102. The tCom clients component is in communication with a tCom core controller 120 outside the corporate LAN 100. As seen in FIG. 4, this communication typically is conducted through a firewall or similar security means 108.

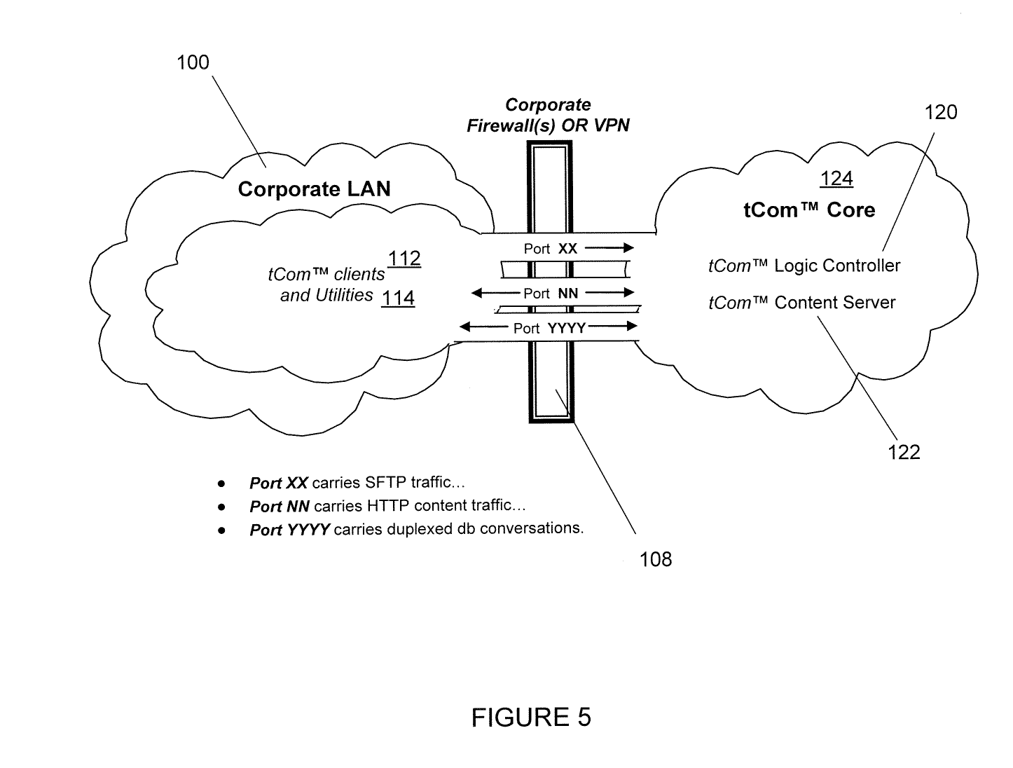

FIG. 5 shows an alternative arrangement of a secure communication system in accordance with another embodiment of the present invention. The corporate LAN 100 includes a tCom clients component 112 and additional tCom utility components 114, which may include the tCom messenger component 110. These components are in communication with the tCom core controller 120. In addition, these components may also be in communication with a tCom content server 122. The tCom content server 122 may be in communication with the tCom core controller 120. As indicated in FIG. 5, the tCom content server and tCom core controller may be components of what is known as the tCom core 124.

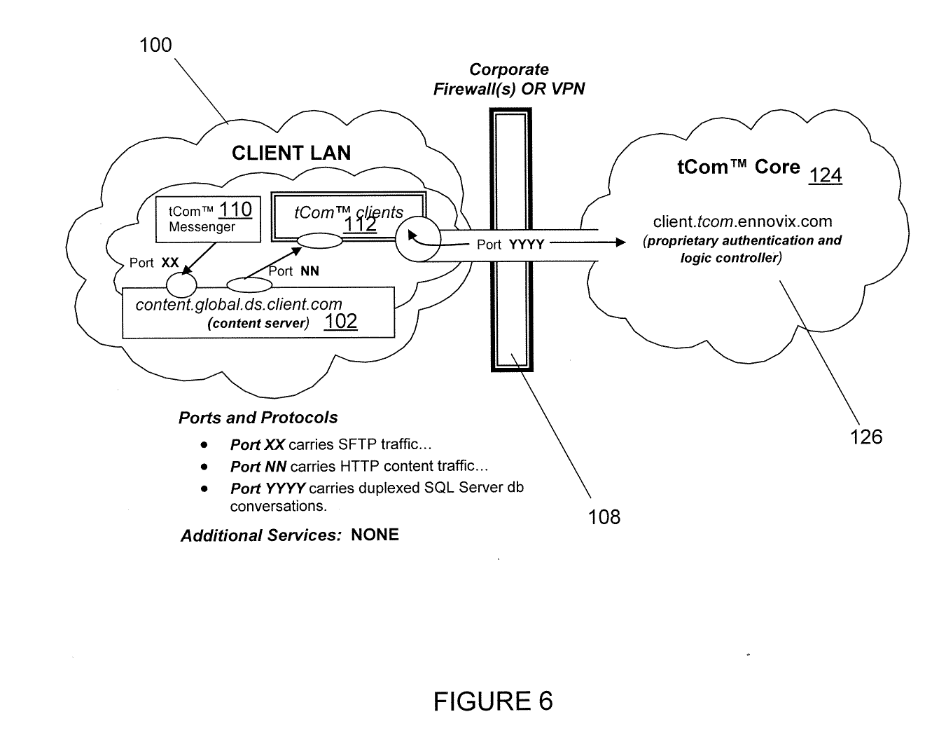

FIG. 6 show another embodiment of a secure communication system, with the proprietary authentication and logic controller element of the tCom core 124 being located at an internet webpage 126.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for the particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A secure communication system, comprising:
a data transmission system for transmitting content, and
a security system integrated with the data transmission system, wherein the security system defaults to lock-out mode, so that any user of the data transmission system must first request access and no access is granted without the request being authenticated.

2. The system of claim 1, wherein content transmitted by the data transmission system is encapsulated.

3. The system of claim 1, wherein content transmitted by the data transmission system is encrypted.

4. The system of claim 1, wherein content transmitted by the data transmission system is encrypted and encapsulated.

5. The system of claim 1, wherein content is tracked.

6. The system of claim 1, further comprising a reporting module that provides information about the transmission of content.

7. The system of claim 1, wherein the content is e-mail.

8. The system of claim 1, wherein the content is video data.

9. The system of claim 1, wherein the content comprises video data, sound data, image data, text data, or a combination thereof.

10. The system of claim 1, wherein content transmitted to a content-receiver can be stored by the content-receiver and accessed at a later time.
